(19) United States
(12) Patent Application Publication
(10) Pub. No.: US 2024/0109992 A1
(43) Pub. Date: Apr. 4, 2024

(54) SYSTEMS AND METHODS FOR LOWERING WATER CONCENTRATION IN POLYACRYLAMIDE-BASED EMULSIONS

(71) Applicant: Ace Fluid Solutions, Odessa, TX (US)

(72) Inventors: Jia Li, Odessa, TX (US); Nicole Ramirez, Odessa, TX (US); Jeff Louis, Odessa, TX (US)

(21) Appl. No.: 17/726,372

(22) Filed: Apr. 21, 2022

(51) Int. Cl. C08F 220/58; C08F 220/56; C08K 3/22; C08K 3/30; C08K 5/103

(52) U.S. Cl. CPC C08F 220/585; C08F 220/56; C08K 3/22; C08K 3/30; C08K 5/103; C08F 2800/20

(57) ABSTRACT

A polyacrylamide-based AMPS (2-acrylamido-2-methylpropane sulfonic acid) copolymer or terpolymer emulsion system may comprise 5-50% solid AMPS salt by weight of a polymer backbone in an emulsion polymerization, wherein use of solid AMPS salt reduces a total amount of water in the emulsion system. The polymer concentration may be above 35% by weight and the water concentration is below 31% by weight. Solid AMPS salt may be dissolved in acrylamide 50% solution, either with or without monomers, to control the total amount of water in an emulsion that may be formed, particularly to lower the water concentration. Use of solid AMPS salt dissolved in acrylamide 50% solution may introduce the AMPS monomer into an emulsion system without requiring addition of extra water. This may improve performance on the polymer backbone as well as the finished emulsion system.

### FIELD OF THE DISCLOSURE

The present disclosure generally relates to anionic polyacrylamide emulsions, and more particularly to lowering water concentration for polyacrylamide-based AMPS (2-acrylamido-2-methylpropane sulfonic acid) copolymer or terpolymer emulsions.

### BACKGROUND

Polyacrylamides are widely used in the oil and gas industry as chemical additives to enhance viscosity and drag reduction in water-based drilling and fracking fluids. Polyacrylamides are produced in two primary forms: a water/oil emulsion and a dry powder. The oil and gas industry prefers emulsions because of a simpler method of addition and blending into the fracking fluid. However, emulsions typically underperform as compared to dry powders in fracking fluids that have a high brine content (water typically having total dissolved solids of more than 100,000 ppm.) As industry operators move away from using freshwater sources and begin to rely on 100% produced or recycled water for their fracking fluids, the formulation and manufacturing of emulsions need to be improved to enhance their performance. This can be accomplished by increasing the active components of the emulsions while reducing the inactive components, such as water.

There is, therefore, a need for systems and methods for producing polyacrylamide-based emulsions with lower concentrations of water.

### SUMMARY

Embodiments of the present disclosure may provide a polyacrylamide-based AMPS (2-acrylamido-2-methylpropane sulfonic acid) copolymer or terpolymer emulsion system comprising: 5-50% solid AMPS salt by weight in a polymer backbone of an emulsion polymerization, wherein use of solid AMPS salt reduces a total amount of water in the emulsion system. Solid AMPS salt, 2-acrylamido-2-methylpropane sulfonic acid sodium salt with linear formula H2C═CHCONHC(CH₃)₂CH₂SO₃Na, is an organic compound with the chromatographic purity of solid composition above 95% and containing less than 10% water.

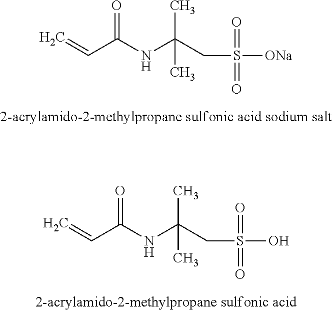

The polymer concentration may be above 35% by weight and the water concentration may be below 31% by weight. The polymer concentration may be above 48% by weight and the water concentration may be below 24% by weight. The polymer concentration may be above 47% by weight and the water concentration may be below 26% by weight.

Other embodiments of the present disclosure may provide a polyacrylamide-based AMPS (2-acrylamido-2-methylpropane sulfonic acid) copolymer or terpolymer emulsion system comprising: 5-50% solid AMPS salt by weight of a polymer backbone dissolved in 50% acrylamide solution, forming a monomer solution; and an oil phase formed of a mixture of (a) an oil emulsifier surfactant or oil emulsifier surfactant package and (b) a mineral oil or a mixture of mineral oils, wherein emulsification of the monomer solution including AMPS with the oil phase forms the emulsion system, and wherein inclusion of solid AMPS salt reduces a total amount of water in the emulsion system. The polymer concentration may be above 35% by weight and the water concentration may be below 31% by weight. The polymer concentration may be above 48% by weight and the water concentration may be below 24% by weight. The polymer concentration may be above 47% by weight and the water concentration may be below 26% by weight. The monomer solution, including acrylamide and AMPS, also may include other monomers like acrylic acid, hydrochloric acid, methacrylic acid, maleic acid, and/or itaconic acid. Synthesizing the polymer also may include oxidants like ammonium persulfate, sodium persulfate, hydrogen peroxide and/or tert-butyl hydroperoxide and/or reductants like bisulfate salts, thiosulfate salt, and/or ferrous salts in the system. The monomer solution also may include sodium hydroxide to buffer the aqueous phase pH.

Further embodiments of the present disclosure may provide a polyacrylamide-based AMPS (2-acrylamido-2-methylpropane sulfonic acid) copolymer or terpolymer emulsion system comprising: 5-50% solid AMPS salt by weight dissolved in 50% acrylamide solution, forming a monomer solution; and an oil phase formed of a mixture of (a) an oil emulsifier surfactant or oil emulsifier surfactant package and (b) a mineral oil or a mixture of mineral oils, wherein emulsification of the AMPS monomer solution with the oil phase forms the emulsion system, wherein inclusion of solid AMPS salt reduces a total amount of water in the emulsion system, and wherein the polymer concentration is above 35% by weight and the water concentration is below 31% by weight. The polymer concentration may be above 48% by weight and the water concentration may be below 24% by weight. The polymer concentration may be above 47% by weight and the water concentration may be below 26% by weight.

Embodiments of the present disclosure may provide a method for producing a polyacrylamide-based AMPS (2-acrylamido-2-methylpropane sulfonic acid) copolymer or terpolymer emulsion system exhibiting a reduced total amount of water, comprising: dissolving AMPS in a 50% acrylamide solution with stirring to create a monomer solution; dispersing the monomer solution in an oil phase formed of a mixture of (a) an oil emulsifier surfactant or oil emulsifier surfactant package and (b) a mineral oil or a mixture of mineral oils; and polymerizing said monomers. The monomer solution may comprise at least one additional type of monomer, the at least one additional type of monomer comprising acrylic acid. The monomer solution may include one or more additional formulation ingredients selected from the group comprising an initiator, a buffer, a reducing agent, or mixtures thereof. The initiator may be ammonium persulfate. The buffer may be selected from the group comprising acrylic acid, hydrochloric acid, sodium hydroxide, or mixtures thereof. The reducing agent may be sodium bisulfate. The surfactant may be sorbitan sesquioleate. The mineral oil may be an organic liquid selected from the group comprising alkanes, cycloalkanes, or mixtures thereof. The polymer concentration may be above 35% by weight and the water concentration may be below 31% by weight in said emulsion system. The polymer concentration may be above 48% by weight and the water concentration may be below 24% by weight in said emulsion system. The polymer concentration may be above 47% by weight and the water concentration may be below 26% by weight in said emulsion system.

### DETAILED DESCRIPTION

2-Acrylamido-2-methylpropane sulfonic acid (AMPS) improves brine and temperature tolerance of polyacrylamide emulsions. Currently, two forms of AMPS monomers may be utilized for polyacrylamide-based AMPS copolymer or terpolymer emulsion synthesis: AMPS powder and AMPS salt 50% solution. Both AMPS monomers introduce additional water into the formulation during the polymerization manufacturing process. The higher water concentration naturally decreases the polymer concentration in the system.

In addition, the extra water introduced by these two traditional forms of AMPS monomer restrict the inverted surfactant type and volume, which is another crucial influence for the brine tolerance of the polyacrylamide emulsion.

Therefore, embodiments of the present disclosure may provide a method for reducing the water content while introducing AMPS monomer in polyacrylamide emulsion.

As described in more detail herein, solid AMPS salt may be dissolved in 50% acrylamide solution, to control the total amount of water in an emulsion that may be formed, particularly to lower the water concentration. Use of solid AMPS salt dissolved in 50% acrylamide solution may introduce the AMPS monomer into an emulsion system without requiring addition of extra water. This may improve performance on the polymer backbone as well as the finished emulsion system. It should be appreciated that the polymer backbone may include 5-50% AMPS monomer by weight to build salt tolerance of the polymer. In an embodiment of the present disclosure, the AMPS powder may be neutralized through introduction of sodium hydroxide. This may introduce a certain amount of water into the resultant emulsion system; the more AMPS that are required, the more water is introduced. In contrast, when a 50% AMPS salt solution is substituted for AMPS powder, this may directly introduce the same amount of water as AMPS salt into the resultant emulsion system.

Three exemplary embodiments of the present disclosure, and three comparative examples prepared according to prior art, are summarized in the TABLE and discussed in the text.

TABLE
Three exemplary embodiments comparative examples.

| | Polymer Concentration with | | | Water Concentration with | | |
|---|---|---|---|---|---|---|
| | Different Form of AMPS, w.t. % | | | Different Form of AMPS, w.t. % | | |
| | Solid AMPS | AMPS Salt | AMPS | Solid AMPS | AMPS Salt | AMPS |
| Embodiment | Salt | 50% Solution | Powder | Salt | 50% Solution | Powder |
| Embodiment 1 | >48% | <38% | <44.5 | <24 | >39 | >29 |
| Embodiment 2 | >35% | <33% | <34 | <31 | >33 | >32 |
| Embodiment 3 | >47% | <37 | <44 | <26 | >36 | >30 |

In a first embodiment, to synthesize 165 grams of AMPS polyacrylamide emulsion, 45 grams of solid AMPS salt may be dissolved in 80 grams of 50% acrylamide solution with stirring to create a monomer solution. Solid AMPS salt may comprise 5-50% by weight of the polymer backbone. 0.15 milligrams of ammonium persulfate may then be added to the monomer solution as an initiator; however, it should be appreciated that other initiators may be used without departing from the present disclosure. 0.3 grams of acrylic acid or hydrochloric acid may then be added to neutralize the pH of the monomer solution. 4.5 grams of sorbitan sesquioleate may be added into 35 grams of mineral oil to form an oil phase. The oil used may be selected from a large class of organic liquids, including alkanes and cycloalkanes, and combinations thereof. The monomer solution may then be mixed with the oil phase to form an emulsion. 1 milligram of sodium bisulfate (a reducing agent) may then be added to the emulsion to synthesize the polymer. In this embodiment, the resultant polymer concentration including solid AMPS salt may be at least 48% by weight with the water concentration below 24% by weight. In a comparative example, the same monomer ratios and emulsion formulation may be used substituting a 50% AMPS salt solution for solid AMPS salt. The resultant polymer concentration including 50% AMPS salt solution may be below 38% with the water concentration above 39% by weight. The resultant polymer concentration including AMPS powder may be below 44.5% with the water concentration above 29% by weight.

In a second embodiment, to synthesize 125 grams of AMPS polyacrylamide emulsion, 5 grams of solid AMPS salt may be dissolved in 80 grams of 50% acrylamide solution to create a monomer solution. 0.15 milligrams of ammonium persulfate may then be added to the monomer solution as an initiator; however, other initiators may be used without departing from the present disclosure. 0.035 grams of acrylic acid or hydrochloric acid may then be added to neutralize the pH of the monomer solution. 4.5 grams of sorbitan sesquioleate or another similar oil emulsifier surfactant may be added into 35 grams of mineral oil to form an oil phase. The oil used may be selected from a large class of organic liquids, including alkanes and cycloalkanes, and combinations thereof. The monomer solution may then be mixed with the oil phase to form an emulsion. 1 milligram of sodium bisulfite may then be added to the emulsion to synthesize the polymer. In this embodiment, the resultant polymer concentration including solid AMPS salt may be at least 35% by weight with the water concentration below 31% by weight. In a comparative example, the same monomer ratios and emulsion formulation may be used substituting a 50% AMPS salt solution for solid AMPS salt. The resultant polymer concentration including 50% AMPS salt solution may be below 33% with the water concentration above 33% by weight. The resultant polymer concentration including AMPS powder may be below 34% with the water concentration above 32% by weight.

In a third embodiment, to synthesize 155 grams of AMPS polyacrylamide emulsion, 25 grams of solid AMPS salt may be dissolved in 80 grams of 50% acrylamide solution and 10 grams of acrylic acid may be added to create a monomer solution. 11 grams of sodium hydroxide may be added to buffer the monomer solution. 0.15 milligrams of ammonium persulfate may then be added to the monomer solution as an initiator; however, other initiators may be used without departing from the present disclosure. 0.05 grams of acrylic acid or hydrochloric acid may then be added to neutralize the pH of the monomer solution. 4.5 grams of sorbitan sesquioleate or other similar oil emulsifier surfactant may be added into 35 grams of mineral oil to form an oil phase. The oil used may be selected from a large class of organic liquids, including alkanes and cycloalkanes, and combinations thereof. The monomer solution may then be mixed with the oil phase to form an emulsion. 1 milligram of sodium bisulfate may then be added to the emulsion to synthesize the polymer. In this embodiment, the resultant polymer concentration including solid AMPS salt may be at least 47% by weight with the water concentration below 26% by weight. In a comparative example, the same monomer ratios and emulsion formulation may be used substituting a 50% AMPS salt solution for solid AMPS salt. The resultant polymer concentration including 50% AMPS salt solution may be below 37% with the water concentration above 35% by weight. The resultant polymer concentration including AMPS powder may be below 44% with the water concentration above 30% by weight.

It can be seen from the foregoing discussion and from the TABLE that each embodiment of the present disclosure has a substantially higher polymer concentration and a substantially lower water concentration than its comparative example which was prepared according to prior art.

Although embodiments of the present disclosure have been found to be independent of the particular emulsion polymerization method employed provided that the specified AMPS monomer is used, certain preferences are delineated in the general description of the emulsion preparation described above in which all percentages are by weight unless otherwise specified.

It should be appreciated that there may be other embodiments where the water concentration may be lowered in the emulsion through evaporation. More specifically, the emulsion may be heated to evaporate the water from the system over time. However, this method may take more time and consume more energy than the other embodiments described herein.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A polyacrylamide-based AMPS (2-acrylamido-2-methylpropane sulfonic acid) copolymer or terpolymer emulsion system comprising:
5-50% solid AMPS salt by weight of a polymer backbone in an emulsion polymerization,
wherein use of solid AMPS salt reduces a total amount of water in the emulsion system.

2. The system of claim 1, wherein the polymer concentration is above 35% by weight and the water concentration is below 31% by weight.

3. The system of claim 1, wherein the polymer concentration is above 48% by weight and the water concentration is below 24% by weight.

4. The system of claim 1, wherein the polymer concentration is above 47% by weight and the water concentration is below 26% by weight.

5. A polyacrylamide-based AMPS (2-acrylamido-2-methylpropane sulfonic acid) copolymer or terpolymer emulsion system comprising:
5-50% solid AMPS salt by weight of a polymer backbone dissolved in 50% acrylamide solution, forming a monomer solution; and
an oil phase formed of a mixture of (a) an oil emulsifier surfactant or oil emulsifier surfactant package and (b) a mineral oil or a mixture of mineral oils,
wherein emulsification of the monomer solution including AMPS with the oil phase forms the emulsion system, and
wherein inclusion of solid AMPS salt reduces a total amount of water in the emulsion system.

6. The system of claim 5, wherein the polymer concentration is above 35% by weight and the water concentration is below 31% by weight.

7. The system of claim 5, wherein the polymer concentration is above 48% by weight and the water concentration is below 24% by weight.

8. The system of claim 5, wherein the polymer concentration is above 47% by weight and the water concentration is below 26% by weight.

9. The system of claim 5, the monomer solution further comprising:
ammonium persulfate, sodium persulfate, hydrogen peroxide, tert-butyl hydroperoxide, bisulfate salts, thiosulfate salt, and/or ferrous salts.

10. The system of claim 5, the monomer solution further comprising:
acrylic acid, hydrochloric acid, methacrylic acid, maleic acid, and/or itaconic acid.

11. The system of claim 5, the monomer solution further comprising:
sodium hydroxide, wherein sodium hydroxide buffers pH of the AMPS monomer solution.

12. The system of claim 5 further comprising:
sodium bisulfite added to the emulsion system to synthesize a polymer.

13. A polyacrylamide-based AMPS (2-acrylamido-2-methylpropane sulfonic acid) copolymer or terpolymer emulsion system comprising:
5-50% solid AMPS salt by weight dissolved in 50% acrylamide solution, forming a monomer solution; and
an oil phase formed of a mixture of (a) an oil emulsifier surfactant or oil emulsifier surfactant package and (b) a mineral oil or a mixture of mineral oils,
wherein emulsification of the monomer solution including AMPS with the oil phase forms the emulsion system,
wherein inclusion of solid AMPS salt reduces a total amount of water in the emulsion system, and
wherein the polymer concentration is above 35% by weight and the water concentration is below 31% by weight.

14. The system of claim 13, wherein the polymer concentration is above 48% by weight and the water concentration is below 24% by weight.

15. The system of claim 13, wherein the polymer concentration is above 47% by weight and the water concentration is below 26% by weight.

16. A method for producing a polyacrylamide-based AMPS (2-acrylamido-2-methylpropane sulfonic acid) copolymer or terpolymer emulsion system exhibiting a reduced total amount of water, comprising:
dissolving AMPS in a 50% acrylamide solution with stirring to create a monomer solution;
dispersing the monomer solution in an oil phase formed of a mixture of (a) an oil emulsifier surfactant or oil emulsifier surfactant package and (b) a mineral oil or a mixture of mineral oils; and
polymerizing said monomers.

17. The method of claim 16, the monomer solution further comprising:
at least one additional type of monomer.

18. The method of claim 17, the at least one additional type of monomer comprising acrylic acid.

19. The method of claim 16, the monomer solution further comprising:
one or more additional formulation ingredients selected from the group comprising an initiator, a buffer, a reducing agent, or mixtures thereof.

20. The method of claim 19, wherein the initiator is ammonium persulfate.

21. The method of claim 19, wherein the buffer is selected from the group comprising acrylic acid, hydrochloric acid, sodium hydroxide, or mixtures thereof.

22. The method of claim 19, wherein the reducing agent is sodium bisulfite.

23. The method of claim 16, wherein the surfactant is sorbitan sesquioleate.

24. The method of claim 16, wherein the mineral oil is an organic liquid selected from the group comprising alkanes, cycloalkanes, or mixtures thereof.

25. The method of claim 16, wherein the polymer concentration is above 35% by weight and the water concentration is below 31% by weight in said emulsion system.

26. The method of claim 16, wherein the polymer concentration is above 48% by weight and the water concentration is below 24% by weight in said emulsion system.

27. The method of claim 16, wherein the polymer concentration is above 47% by weight and the water concentration is below 26% by weight in said emulsion system.
